(19) United States
(12) Patent Application Publication
(10) Pub. No.: US 2023/0387604 A1
(43) Pub. Date: Nov. 30, 2023

(54) MMWAVE ANTENNA ARRANGEMENT AND MODULE COMPRISING SUCH ARRANGEMENT

(71) Applicant: HUAWEI TECHNOLOGIES CO., LTD., Shenzhen (CN)

(72) Inventors: Ruiyuan Tian, Helsinki (FI); Janne Ilvonen, Helsinki (FI); Alexander Khripkov, Helsinki (FI); Fengwen Chen, Dongguan (CN); Dong Liu, Dongguan (CN); Wei Shan, Shanghai (CN)

(21) Appl. No.: 18/323,205

(22) Filed: May 24, 2023

Related U.S. Application Data
(63) Continuation of application No. PCT/CN2020/131211, filed on Nov. 24, 2020.

(51) Int. Cl. H01Q 21/06; H01Q 9/04

(52) U.S. Cl. CPC H01Q 21/065; H01Q 9/0414

(57) ABSTRACT

A millimeter-wave antenna arrangement (1) comprising at least one first antenna array (2), said first antenna array (2) comprising a plurality of antenna elements (2a) such as patch antennas, and an artificial dielectric structure (3) superposed over said first antenna array (2). Said artificial dielectric structure (3) comprises a plurality of conductor layers (4) separated by dielectric layers (5), each conductor layer (4) comprising a plurality of periodically repeated conductor patterns (6). One conductor pattern (6) of each conductor layer (4) is associated with one of said antenna elements (2a), and the conductor patterns (6) associated with one antenna element (2a) are at least partially non-identical. Said artificial dielectric structure (3) has an artificial dielectric constant, and each dielectric layer has a natural dielectric constant, said artificial dielectric constant depending at least partially on the natural dielectric constants and preferably having a value between 10-30.

This configuration provides a way of achieving multi-surface beam coverage, e.g. by means of end-fire antenna elements as well as broadside antenna elements, while maintaining a compact footprint.

### CROSS-REFERENCE TO RELATED APPLICATIONS

This application is a continuation of International Application No. PCT/CN2020/131211, filed on Nov. 24, 2020, the disclosure of which is hereby incorporated by reference in its entirety.

### TECHNICAL FIELD

The disclosure relates to a millimeter-wave antenna arrangement comprising an antenna array and an artificial dielectric structure.

### BACKGROUND

Electronic devices need to support more and more cellular radio technology such as 2G/3G/4G radio as well as non-cellular radio technology. In the coming 5G new radio technology, the used frequency range will be expanded from so-called sub-6 GHz to millimeter-wave (mmWave) frequency, e.g. above 20 GHz. For mmWave frequencies, an antenna array will be necessary in order to form a radiation beam with higher gain which overcomes the higher path loss in the propagation media. However, radiation beam patterns with higher gain result in a narrow beam width, wherefore beam steering techniques such as phased antenna arrays are used to steer the beam in specific directions on demand.

Mobile electronic apparatuses, such as smartphones and tablets, can be oriented in any arbitrary direction. Therefore, such apparatuses need to exhibit an as near full spherical beam coverage as possible, making dual-polarization a necessity in order to achieve stable communication in all directions and orientations.

Conventionally, a mmWave antenna is implemented in a module which, in turn, is fixed to the main printed circuit board (PCB) of the apparatus. The PCB may comprise an antenna array where the main radiation beam direction is the broadside direction, i.e., perpendicular to the display of the apparatus. The PCB may also be configured such that the main radiation beam direction is the end-fire direction, i.e., parallel to the display of the apparatus.

The integration of such modules into a mobile apparatus is challenging due to the limited space available, due to several modules being necessary in order to achieve sufficiently good multi-surface spherical beam coverage, and include broadside as well as end-fire antenna directionality.

### SUMMARY

It is an object to provide an improved millimeter-wave antenna arrangement. The foregoing and other objects are achieved by the features of the independent claims. Further implementation forms are apparent from the dependent claims, the description, and the figures.

According to a first aspect, there is provided a millimeter-wave antenna arrangement comprising at least one first antenna array, the first antenna array comprising a plurality of antenna elements and an artificial dielectric structure superposed over the first antenna array. The artificial dielectric structure comprises a plurality of conductor layers separated by dielectric layers, each conductor layer comprising a plurality of periodically repeated conductor patterns, one conductor pattern of each conductor layer being associated with one of the antenna elements, the conductor patterns associated with one antenna element being at least partially non-identical.

This configuration provides a way of achieving multi-surface beam coverage while maintaining a compact footprint. The antenna arrangement, using the artificial dielectric structure instead of the natural dielectric material, is reliable and stable, and has good performance, since the surface shape of the antenna array, and hence the physical interface between antenna array and dielectric structure need not be considered during assembly. For example, the step of fitting dummy antenna patches in order to achieve a flatter antenna array surface can be disposed of. Furthermore, the conductor patterns can be engineered such that a high dielectric constant is achieved for the artificial dielectric structure, while still maintaining a relatively low height. With a high artificial dielectric constant, the size of the antenna array can be made smaller, while improving the directivity of the array. Furthermore, this facilitates an anisotropic artificial dielectric structure, e.g. having different artificial dielectric constants for different polarizations and/or different areas.

In a possible implementation form of the first aspect, the antenna element is a patch antenna.

In a further possible implementation form of the first aspect, the first antenna array and the artificial dielectric structure extend in parallel planes, one antenna element and one conductor pattern of at least one conductor layer forming an antenna column in a direction perpendicular to the planes.

In a further possible implementation form of the first aspect, the conductor patterns within one conductor layer are identical

In a further possible implementation form of the first aspect, each conductor pattern comprises a plurality of conductor patches, and the conductor patterns are arranged such that one conductor pattern of one conductor layer is superposed with one antenna element and one corresponding conductor pattern of at least one further conductor layer.

In a further possible implementation form of the first aspect, each conductor pattern is separated from adjacent conductor patterns by a dielectric gap wider than a corresponding dielectric gap between adjacent conductor patches within a conductor pattern. This allows each antenna element to be coupled to an area having a high artificial dielectric constant while isolating the antenna elements from each other.

In a further possible implementation form of the first aspect, the conductor patches of each conductor pattern are separated by dielectric gaps, isolating the conductor patterns from each other.

In a further possible implementation form of the first aspect, the conductor patch comprises copper.

In a further possible implementation form of the first aspect, the conductor patches of one conductor pattern are one of identical and non-identical in size and/or shape, facilitating isotropy as well as anisotropy throughout the artificial dielectric structure.

In a further possible implementation form of the first aspect, the conductor pattern comprises at least four conductor patches.

In a further possible implementation form of the first aspect, the conductor patches are rectangular and arranged in an m×n matrix pattern.

In a further possible implementation form of the first aspect, the artificial dielectric structure has an artificial dielectric constant and each dielectric layer has a natural dielectric constant, the artificial dielectric constant depending at least partially on the natural dielectric constant(s). This facilitates a dielectric structure which is more reliable than conventional dielectric materials since there are no interface issues, between antenna array and dielectric, to consider.

In a further possible implementation form of the first aspect, the artificial dielectric constant is additionally depends on the number of conductor layers, the distance between adjacent conductor layers, the size of the conductor patches, and the size of the gaps between the conductor patches within one conductor pattern, allowing the artificial dielectric constant to be tuned in response to a variety of characteristics.

In a further possible implementation form of the first aspect, the artificial dielectric constant has a value higher than the natural dielectric constant such that an improved insulation is achieved.

In a further possible implementation form of the first aspect, the artificial dielectric constant has a value between 10 and 30, i.e. a relatively high dielectric constant.

In a further possible implementation form of the first aspect, the artificial dielectric structure is integrated with the first antenna array or the artificial dielectric structure is a separate structure attached to the first antenna array.

In a further possible implementation form of the first aspect, each conductor pattern is coupled to at least one switch, the switch being configured to affect a size and/or shape of the conductor pattern, the change in conductor pattern changing the artificial dielectric constant.

In a further possible implementation form of the first aspect, the size and/or shape of the conductor pattern is affected by activating and deactivating of the switch, providing a simple and reliable way of tuning the artificial dielectric constant.

According to a second aspect, there is provided a millimeter-wave antenna module comprising the millimeter-wave antenna arrangement according the above and a substrate configured to accommodate at least the antenna arrangement. The first antenna array of the antenna arrangement is arranged between a section of the substrate and the artificial dielectric structure of the antenna arrangement. This configuration provides multi-surface beam coverage while maintaining a compact footprint. The module can be flexibly designed to support either single-surface or multi-surface beam coverage.

In a possible implementation form of the second aspect, the substrate comprises a first substrate section and a second substrate section, the first substrate section and the second substrate section optionally being interconnected by a third substrate section, the second substrate section extending at an angle to the first substrate section, the first antenna array being arranged on the first substrate section. The third substrate section may be made thinner than the first substrate section and the second substrate section such that it bends easily and also takes up as little space as possible within an apparatus comprising the antenna module.

In a further possible implementation form of the second aspect, the first antenna array is integrated with the first substrate section and/or the third substrate section, or the first antenna array is a separate structure attached to the first substrate section and/or the third substrate section, improving assembly tolerances and/or the flexibility of the assembly process.

In a further possible implementation form of the second aspect the millimeter-wave antenna module further comprises at least one second antenna array, the second antenna array being arranged on the second substrate section. This allows the antenna module to comprise both end-fire antenna elements and broadside antenna elements, improving multi-surface beam coverage of the antenna module.

In a further possible implementation form of the second aspect the millimeter-wave antenna module further comprises a radio frequency integrated circuit, the radio frequency integrated circuit optionally being arranged on the second substrate section.

In a further possible implementation form of the second aspect the second antenna array is arranged on a first side of the second substrate section and the radio frequency integrated circuit is arranged on a second side of the second substrate section, facilitating an as small module footprint as possible.

In a further possible implementation form of the second aspect, the first substrate section and/or the third substrate section comprise transmission lines configured to transmit at least one signal between the first antenna array and the radio frequency integrated circuit.

In a further possible implementation form of the second aspect, the substrate is a printed circuit board.

According to a third aspect, there is provided an apparatus comprising a millimeter-wave antenna module according to the above, a chassis, and a housing at least partially enclosing the antenna module and the chassis. This allows for an apparatus with good multi-surface beam coverage as well as a compact footprint.

In a possible implementation form of the third aspect, the housing comprises at least a main surface and a peripheral surface extending along the periphery of the main surface and at an angle to the main surface, the first substrate section of the antenna module extending adjacent the peripheral surface, the artificial dielectric structure of the antenna module being located between the first antenna array of the antenna module and the peripheral surface, taking advantage of existing spaces within the apparatus.

In a further possible implementation form of the third aspect, the second substrate section of the antenna module extends at least partially parallel with the main surface, the second antenna array of the antenna module facing the main surface, the radio frequency integrated circuit of the antenna module facing an interior of the housing. This allows the performance of the antenna module to be improved while protecting related components.

In a further possible implementation form of the third aspect, the configuration, in size and/or shape, of each individual conductor pattern associated with one antenna element of the antenna module is dependent on adjacent structural components, optionally the housing and/or the chassis, of the apparatus, allowing the characteristics of structures forming the immediate surroundings of the antenna module to be considered.

In a further possible implementation form of the third aspect, conductor patches of a conductor pattern arranged immediately adjacent a dielectric structural component of the apparatus, optionally a back cover, have a first surface area size and/or shape, and conductor patches of a conductor pattern arranged immediately adjacent a conductive structural component of the apparatus, optionally the chassis, have a second surface area size and/or shape.

These and other aspects will be apparent from the embodiments described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1a shows a schematic side view of an artificial dielectric structure according to an embodiment of the present invention;

FIG. 1b shows top views of different conductor layers of an artificial dielectric structure according to an embodiment of the present invention;

FIG. 2a-e show different conductor patterns of conductor layers according to embodiments of the present invention;

FIG. 3 shows a perspective view of a millimeter-wave antenna module according to an embodiment of the present invention;

FIG. 4 shows a bottom view of the embodiment of FIG. 3;

FIG. 5 shows a top vies of a millimeter-wave antenna module according to an embodiment of the present invention;

FIG. 6 shows a partial cross-sectional view of an apparatus comprising a millimeter-wave antenna module according to an embodiment of the present invention;

FIG. 7 shows a top view of a millimeter-wave antenna arrangement according to an embodiment of the present invention.

### DETAILED DESCRIPTION

FIG. 7 shows a millimeter-wave antenna arrangement 1 comprising at least one first antenna array 2 and an artificial dielectric structure 3 superposed over the first antenna array 2.

The first antenna array 2 comprises a plurality of antenna elements 2a. The antenna elements 2a may be patch antennas.

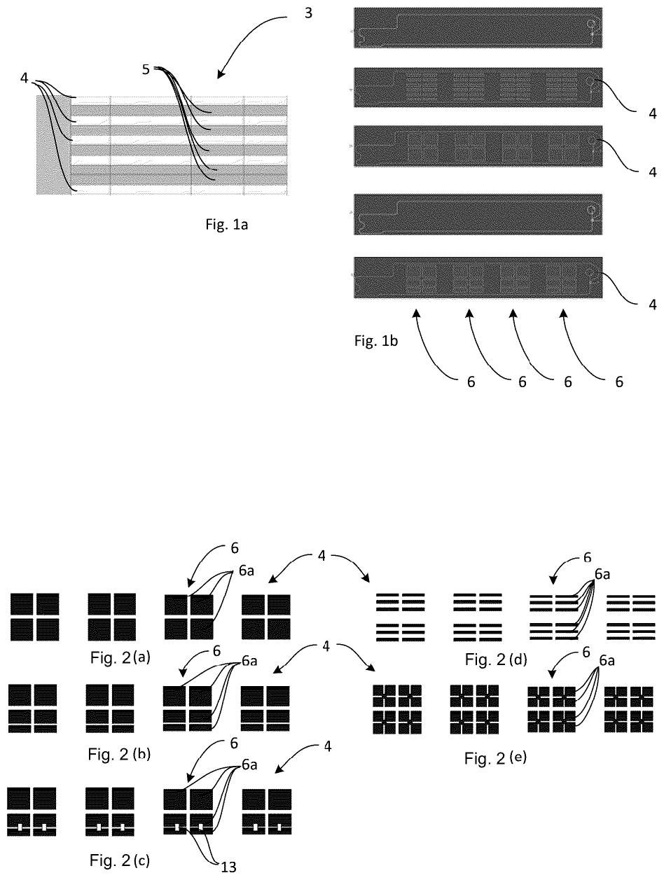

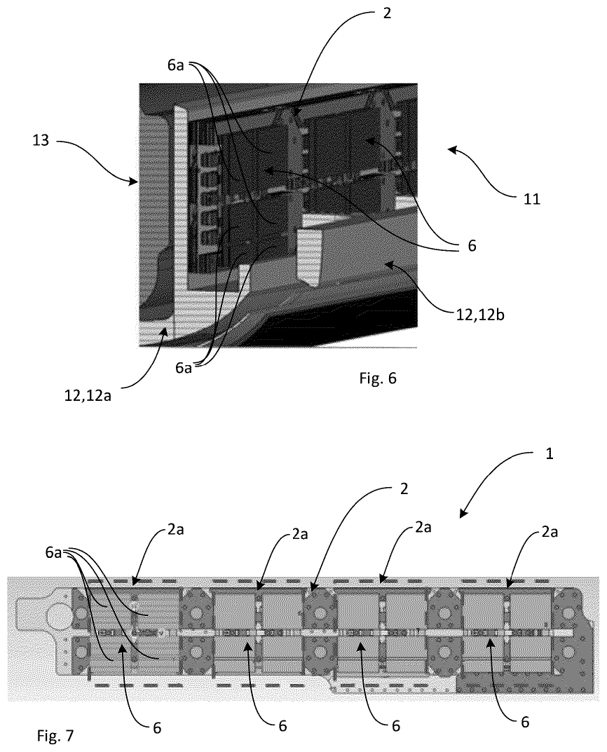

As shown in FIG. 1a, the artificial dielectric structure 3 comprises a plurality of conductor layers 4 separated by dielectric layers 5. The artificial dielectric structure 3 may integrated with the first antenna array 2 (not shown) or the artificial dielectric structure 3 may be a separate structure attached to the first antenna array 2, as shown in FIGS. 6 and 7, by means of soldering or adhesives such as tape or glue.

Each conductor layer 4 comprises a plurality of periodically repeated conductor patterns 6, as shown in FIG. 1b. One conductor pattern 6 of each conductor layer 4 is associated with one of the antenna elements 2a.

The first antenna array 2 and the artificial dielectric structure 3 may extend in parallel planes, one antenna element 2a and one conductor pattern 6 of at least one conductor layer 4 forming an antenna column in a direction perpendicular to the planes. The conductor patterns 6 may, in other words, be arranged such that one conductor pattern 6 of one conductor layer 4 is superposed with one antenna element 2a and one corresponding conductor pattern 6 of at least one further conductor layer 4. FIG. 1b shows a number of conductor layers 4 to be stacked on top of each along with dielectric layers 5, each conductor layer 4 having four conductor patterns 6, i.e. forming four antenna columns.

As shown in FIGS. 2a-e, each conductor pattern 6 may comprise a plurality of conductor patches 6a. A conductor pattern 6 may comprise any suitable number or size of conductor patches 6a, including just one conductor patch. FIG. 1b shows, as seen from the top of the figure, antenna columns comprising a conductor pattern 6 having twelve conductor patches 6a, a conductor pattern 6 having four conductor patches 6a, and a conductor pattern 6 having six conductor patches 6a.

The conductor patterns 6 within each individual conductor layer 4 may be identical, nevertheless, at least one conductor layer 4 may comprise conductor patterns 6 which are non-identical, as suggested in FIG. 2a where the two rightmost conductor patterns 6 have conductor patches 6a with slightly smaller surface areas than the two leftmost conductor patterns 6. This allows the artificial dielectric structure 3 to be anisotropic with regards to the artificial dielectric constant, for e.g. different polarizations and/or different areas. Furthermore, as shown in FIG. 1b, the conductor patterns 6 associated with one antenna element 2a may be at least partially non-identical, i.e. have different shapes, sizes and/or number of conductor patches 6a.

The conductor patches 6a of each conductor pattern 6 may be separated by dielectric gaps as shown in FIGS. 1b, 2a-e, and 7. Correspondingly, each conductor pattern 6 may be separated from adjacent conductor patterns 6 by a dielectric gap wider than a corresponding dielectric gap between adjacent conductor patches 6a within a conductor pattern, as also shown in FIGS. 1b and 7.

The conductor patches 6a of one conductor pattern 6 may be one of identical in size and/or shape, as shown in FIGS. 2a, 2d, 2e, and 7, and non-identical, as shown in FIGS. 2b and 2c.

The conductor pattern 6 may comprise at least four conductor patches 6a. The conductor patches 6a may be rectangular and arranged in an m×n matrix pattern, as shown in FIGS. 1b, 2a-e, and 7. The conductor patch 6a may comprise copper material.

The artificial dielectric structure 3 has an artificial dielectric constant, and each dielectric layer 5 has a natural dielectric constant. The artificial dielectric constant depends at least partially on the natural dielectric constants. The artificial dielectric constant may additionally depend on the number of conductor layers 4, the distance between adjacent conductor layers 4, the size of the conductor patches 6a, and the size of the gaps between the conductor patches 6a within one conductor pattern 6. Preferably, the artificial dielectric constant has a value which is higher than the natural dielectric constant. The value of the artificial dielectric constant may be in a range between 10 and 30, preferably around 20.

Each conductor pattern 6 may be coupled to at least one switch 13, as shown in FIG. 2c. The switch 13 is configured to affect a size and/or shape of the conductor pattern 6, the change in conductor pattern 6 in turn changing the value of the artificial dielectric constant such that the artificial dielectric constant can be tuned to a specific need. The size and/or shape of the conductor pattern 6 is affected by activating and deactivating the switch 13, e.g. turning the switch 13 on and off by controlling the voltage.

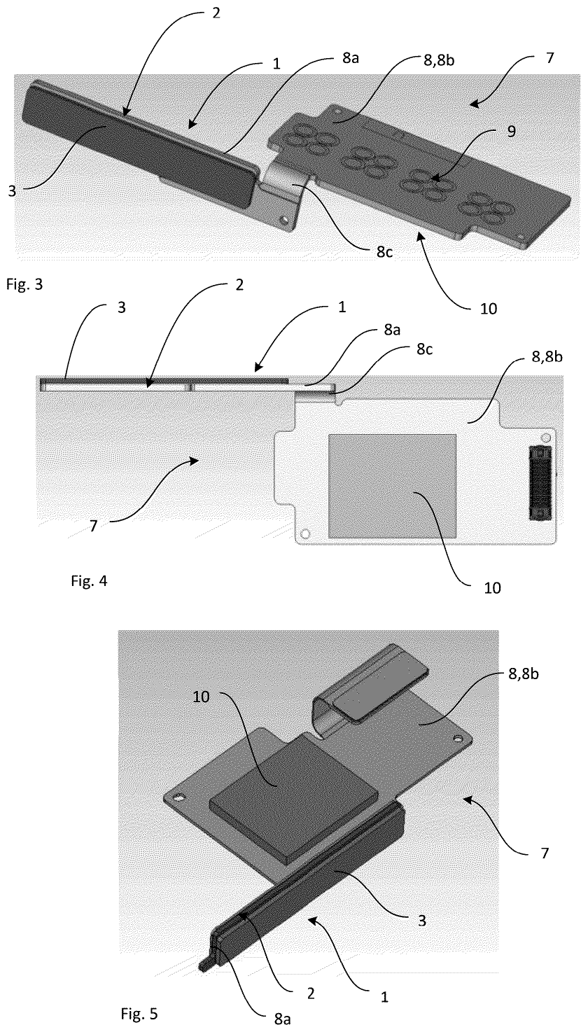

FIGS. 3 to 5 show a millimeter-wave antenna module 7 comprising the above-mentioned millimeter-wave antenna arrangement 1 and a substrate 8 configured to accommodate at least the antenna arrangement 1. The first antenna array 2 of the antenna arrangement 1 is arranged between a section of the substrate 8 and the artificial dielectric structure 3 of the antenna arrangement 1, such that the artificial dielectric structure 3 is arranged on top of the first antenna array 2, i.e. the artificial dielectric structure 3 is arranged closer to the exterior while the first antenna array 2 is arranged closer to the interior of an apparatus comprising the antenna module 7. The substrate 8 may be a printed circuit board.

The substrate 8 may comprise a first substrate section 8a and a second substrate section 8b, as shown in FIGS. 3 to 5. The first substrate section 8a and the second substrate section 8b may be interconnected by a third substrate section 8c, as shown in FIGS. 3 and 4. The second substrate section 8b extends at an angle, e.g. 90°, to the first substrate section 8a, but any suitable angle is possible.

The first antenna array 2 is arranged on the first substrate section 8a. The first antenna array 2 may integrated with the first substrate section 8a and/or the third substrate section 8c (not shown). The first antenna array 2 may also be a separate structure attached to the first substrate section 8a, as shown in FIGS. 3 to 5, and/or the third substrate section 8c (not shown).

The millimeter-wave antenna module 7 may further comprise at least one second antenna array 9, the second antenna array 9 being arranged on the second substrate section 8b as shown in FIG. 3. Such an antenna module 7 may be arranged such that the second substrate section 8b and the second antenna array 9 extend immediately adjacent a backcover of an apparatus 11 comprising the antenna module 7, as would be the case for the embodiments shown in FIGS. 3 and 4. An antenna module 7 which does not have a second antenna array 9 may be arranged such that the second substrate section 8b extends immediately adjacent a display of an apparatus 11 comprising the antenna module 7, as would be the case for the embodiment shown in FIG. 5.

The millimeter-wave antenna module 7 may also comprise a radio frequency integrated circuit 10, the radio frequency integrated circuit 10 optionally being arranged on the second substrate section 8b as shown in FIG. 4. The first substrate section 8a and/or the third substrate section 8c may comprise transmission lines configured to transmit at least one signal between the first antenna array 2 and the radio frequency integrated circuit 10. The transmission lines may be routed on the substrate 8 and connected to the radio frequency integrated circuit 10 by means of, e.g., soldering or conductive tape.

As shown in FIG. 3, the second antenna array 9 may be arranged on a first side of the second substrate section 8b and the radio frequency integrated circuit 10 may be arranged on a second side of the second substrate section 8b.

The present invention also relates to an apparatus 11 comprising a millimeter-wave antenna module 7 according to the above, a chassis 13, and a housing 12 at least partially enclosing the antenna module 7 as shown in FIG. 6. The housing 12 comprises at least a cover, such as a back cover, and a display.

The housing 12 may comprise at least a main surface 12a, such as a display side or a back cover side of the apparatus, and a peripheral surface 12b extending along the periphery of the main surface 12a and at an angle to the main surface 12a, such as a side frame arranged between the back cover side and the display side of the apparatus.

The antenna module 7 is arranged such that the first substrate section 8a of the antenna module 7 extends adjacent the peripheral surface 12b, and the artificial dielectric structure 3 of the antenna module 7 is located between the first antenna array 2 of the antenna module 7 and the peripheral surface 12b, allowing end-fire from the first antenna array 2.

The second substrate section 8b of the antenna module 7 may extend at least partially parallel with the main surface 12a, i.e. in parallel with the display side and/or the back cover side and immediately adjacent, or at a distance from, the main surface 12a. If the second substrate section 8b is provided with a second antenna array 9, the second antenna array 9 is preferably arranged such that it faces the main surface 12a. The radio frequency integrated circuit 10 of the antenna module 7 faces the interior of the housing 12, for example the chassis 13. The antenna module 7 shown in FIGS. 3 and 4, if arranged as shown in FIG. 6, would have the second antenna array 9 arranged adjacent main surface 12a in the form of a back cover, such that the second antenna array 9 radiates only in the direction of the back cover, so-called broadside radiation. Radiation in the direction of the display would be blocked by the conductive display. The antenna module 7 shown in FIG. 5 is arranged as shown in FIG. 6, the module would not comprise a second antenna array 9. Hence, the second substrate section 8b can be arranged adjacent a main surface 12a in the form of a display. The radio frequency integrated circuit 10, when arranged on the second substrate section 8b, may be arranged between the chassis 13 and the display main surface 12a, or optionally between the chassis 13 and the back cover main surface 12a.

The configuration, in size and/or shape, of each individual conductor pattern 6 associated with one specific antenna element 2a may depend on the characteristics of any adjacent structural components, such as the housing 12 and/or the chassis 13, of the apparatus 11. The conductor patches 6a of a conductor pattern arranged immediately adjacent a dielectric structural component of said apparatus, such as a back cover made of glass or plastic, may have a first surface area size and/or shape. Correspondingly, the conductor patches 6a of a conductor pattern arranged immediately adjacent a conductive structural component of said apparatus, such as a chassis made of steel or aluminum, may have a second surface area size and/or shape. The first surface area may be larger than said second surface area, or the opposite.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

What is claimed is:

1. A millimeter-wave antenna arrangement comprising
at least one first antenna array comprising a plurality of antenna elements;
an artificial dielectric structure superposed over the first antenna array, wherein the artificial dielectric structure comprises a plurality of conductor layers separated by dielectric layers;
each conductor layer comprising a plurality of periodically repeated conductor patterns,
wherein one conductor pattern of each conductor layer is associated with one of the antenna elements, and wherein the conductor patterns associated with one antenna element are at least partially non-identical.

2. The millimeter-wave antenna arrangement according to claim 1, wherein each conductor pattern comprises a plurality of conductor patches, and
wherein the conductor patterns are arranged such that one conductor pattern of one conductor layer is superposed with one antenna element and one corresponding conductor pattern of at least one further conductor layer.

3. The millimeter-wave antenna arrangement according to claim 1, wherein the artificial dielectric structure has an artificial dielectric constant, wherein each dielectric layer has a natural dielectric constant, and wherein the artificial dielectric constant depends at least partially on the natural dielectric constant.

4. The millimeter-wave antenna arrangement according to claim 3, wherein the artificial dielectric constant additionally depends on a number of conductor layers, a distance between adjacent conductor layers, a size of the conductor patches and a size of gaps between the conductor patches within one conductor pattern.

5. The millimeter-wave antenna arrangement according to claim 3, wherein the artificial dielectric constant has a value higher than the natural dielectric constant.

6. The millimeter-wave antenna arrangement (1) according to any one of claims 3 to 5, wherein each conductor pattern (6) is coupled to at least one switch (13), said switch being configured to affect a size and/or shape of said conductor pattern (6), said change in conductor pattern (6) changing said artificial dielectric constant.

7. A millimeter-wave antenna module comprising
the millimeter-wave antenna arrangement according to claim 1;
a substrate configured to accommodate at least the millimeter-wave antenna arrangement (1),
wherein the first antenna array of the millimeter-wave antenna arrangement is arranged between a section of the substrate and the artificial dielectric structure of the antenna arrangement.

8. The millimeter-wave antenna module according to claim 7, wherein the substrate comprises a first substrate section and a second substrate section, wherein the first substrate section and the second substrate section is interconnected by a third substrate section, wherein the second substrate section extends at an angle to the first substrate section, and wherein the first antenna array is arranged on the first substrate section.

9. The millimeter-wave antenna module according to claim 8, further comprising at least one second antenna array arranged on the second substrate section.

10. The millimeter-wave antenna module according to claim 8, further comprising a radio frequency integrated circuit arranged on the second substrate section.

11. The millimeter-wave antenna module according to claim 9, wherein the second antenna array is arranged on a first side of the second substrate section and the radio frequency integrated circuit is arranged on a second side of the second substrate section.

12. The millimeter-wave antenna module according to claim 10, wherein the first substrate section and/or the third substrate section comprise transmission lines configured to transmit at least one signal between the first antenna array and the radio frequency integrated circuit.

13. The millimeter-wave antenna module according to claim 7, wherein the substrate is a printed circuit board.

14. An apparatus comprising a millimeter-wave antenna module according to claim 1, a chassis, and a housing at least partially enclosing the antenna module and the chassis.

15. The apparatus according to claim 14, wherein the housing comprises at least a main surface and a peripheral surface extending along the periphery of the main surface and at an angle to the main surface,
wherein the first substrate section of the antenna module extends adjacent the peripheral surface, and
wherein the artificial dielectric structure of the antenna module is located between the first antenna array of the antenna module and the peripheral surface.

16. The apparatus according to claim 14, wherein the second substrate section of said antenna module extends at least partially parallel with said main surface, the second antenna array of said antenna module facing said main surface,
the radio frequency integrated circuit of said antenna module facing an interior of said housing (12).

17. The apparatus according to claim 14, wherein the configuration, in size and/or shape, of each individual conductor pattern associated with one antenna element of the antenna module is dependent on adjacent structural components.

18. The apparatus according to claim 17, wherein the configuration, in size and/or shape, of each individual conductor pattern associated with one antenna element of the antenna module is further dependent on the housing and/or the chassis of the apparatus.
